(19) United States
(12) Patent Application Publication
(10) Pub. No.: US 2010/0326649 A1
(43) Pub. Date: Dec. 30, 2010

(54) Swellable Oilfield Apparatus and Methods of Forming

(75) Inventors: Keith Spacey, Manchester (GB); Kim Nutley, Aberdeenshire (GB); Brian Nutley, Aberdeen (GB)

Correspondence Address: (Weatherford) Wong Cabello Lutsch Rutherford &;Brucculeri LLP, 20333 Tomball Parkway, 6th floor, Houston, TX, 77070, US

(73) Assignee: Swelltec Limited, Dyce (GB)

(21) Appl. No.: 12/819,308

(22) Filed: Jun. 21, 2010

(30) Foreign Application Priority Data
Jun. 26, 2009 (GB) 0911085.9

(51) Int. Cl. E21B 33/12; B05D 7/02

(52) U.S. Cl. 166/179; 427/569

(57) ABSTRACT

A method of forming a swellable oilfield apparatus and an oilfield apparatus so-formed are described. In the method, a body of swellable elastomeric material which increases in volume on exposure to at least one triggering fluid is provided, and the surface energy of the swellable elastomeric material is modified to increase the water-wettability of the swellable elastomeric material. In one embodiment, the swellable elastomeric material comprises a base elastomer and at least one additive selected to modify the surface energy. In another, the swellable elastomeric material comprises a base elastomer treated by an electrical treatment process to modify the surface energy of the swellable elastomeric material. The invention provides improved swelling performance in aqueous fluids.

### CROSS REFERENCE TO RELATED APPLICATIONS

This application claims priority to U.K. Patent Application Serial No. GB0911085.9 entitled “Swellable oilfield apparatus and methods of forming” filed Jun. 26, 2009 and which is incorporated by reference in its entirety herein.

### TECHNICAL FIELD

The present invention relates to the field of swellable apparatus for the hydrocarbon exploration and production industries, and in particular to elastomeric compositions for use in swellable apparatus, and apparatus incorporating such compositions. Embodiments of the invention relate to isolation and sealing applications which use swellable apparatus including wellbore packers.

### BACKGROUND ART

In the field of hydrocarbon exploration and production, various tools are used to provide fluid seals between two components in a wellbore Annular barriers have been designed for preventing undesirable flow of wellbore fluids in the annulus between a wellbore tubular and the inner surface of a surrounding tubular or the borehole wall. In many cases, the annular barriers provide a fluid seal capable of holding a significant pressure differential across its length. In one application, a wellbore packer is formed on the outer surface of a completion string which is run into an outer casing in a first condition having a particular outer diameter. When the packer is in its desired downhole location, it is inflated or expanded into contact with the inner surface of the outer casing to create a seal in the annulus. Similar wellbore packers have been designed for use in openhole environments, to create a seal between a tubular and the surrounding wall of the wellbore.

Conventional packers are actuated by mechanical or hydraulic systems. A force or pressure is applied from surface to radially move a mechanical packer element into contact with the surrounding surface. In an inflatable packer, fluid is delivered from surface to inflate a chamber defined by a bladder around the tubular body.

More recently, wellbore packers have been developed which include a mantle of swellable material formed around the tubular. The swellable material is selected to increase in volume on exposure to at least one predetermined fluid, which may be a hydrocarbon fluid or an aqueous fluid or brine. The swellable packer may be run to a downhole location in its unexpanded state, where it is exposed to a wellbore fluid and caused to increase in volume. The design, dimensions, and swelling characteristics are selected such that the swellable packer element expands to create a fluid seal in the annulus to isolate one wellbore section from another. Swellable packers have several advantages over conventional packers, including passive actuation, simplicity of construction, and robustness in long term isolation applications.

The materials selected to form a swellable element in a swellable packer vary depending on the specific application. Swellable materials are elastomeric (i.e. they display mechanical and physical properties of an elastomer or natural rubber). Where the swellable mantle is designed to swell in hydrocarbons, it may comprise a material such as an ethylene propylene diene monomer (EPDM) rubber. Where the swellable mantle is required to swell in aqueous fluids or brines, the material may for example comprise an N-vinyl carboxylic acid amide-based crosslinked resin and a water swellable urethane in an ethylene propylene rubber matrix. Suitable materials for swellable packers are described for example in GB 2411918.

In certain applications it is desirable to have a well packer that swells on exposure to hydrocarbons and water. Such well packers comprise material that is capable of swelling upon contact with hydrocarbons and material that is capable of swelling upon contact with water or brine. Such materials may be referred to as “hybrid” swelling materials. A well packer that swells upon contact with both hydrocarbons and water may provide for a proper seal during both the initial and the subsequent stages of production. During an early stage of production the production fluid may be comprised essentially of hydrocarbons and during later stages of production the water content of the production fluid may increase.

WO 05/012686 discloses a swellable material for downhole applications comprising an elastomeric matrix material to which has been added super absorbent polymer (SAP) particles. Such SAP particles can be classified into starch systems, cellulose systems and synthetic resin systems. The SAPs have hydrophilic characteristics by virtue of the presence of alcohols, carboxylic acids, amides or sulphuric acids. Cross-linking between the particles creates a three dimensional network. A salt is mixed with and bound to the material to maintain the desired diffusion gradient and allow for continued absorption of water (and thus continued swelling) in saline conditions.

US 2007/0027245 discloses oilfield elements and assemblies comprising elastomeric compositions capable of swelling in oil and/or water. The compositions comprise the reaction product of a linear or branched polymer having a residual ethylenic unsaturation with an unsaturated organic monomer having at least one acidic reactive moiety. The function of the reactive moiety is stated to be to attach (grafted) and/or blend in hydrophilic sites and lend water-swelling characteristics to the elastomer. In one example, a water-swellable elastomer is formed by grafting an unsaturated organic acid onto a linear or branched ethylene olefin-based elastomer having residual unsaturation (such as EPDM). In another, an elastomer such as nitrile is added to an EPDM polymer with a sufficient amount of an unsaturated organic acid.

The applicant's co-pending WO2008/155564 addresses the problem of swelling performance of a swellable elastomeric material in water and brines by providing access pathways which permit passage of water to water-swellable elastomer bodies. In one embodiment, the access pathways are bores created by perforations, and in another the access pathways are formed due to changes in the macroscopic bond structure created by a polymer additive.

Although adequate swelling performance has been found with the compounds described in the prior art, there is generally a need for improved swelling rates, larger swell volumes, and elastomer stability in aqueous fluids, and in particular in brines with high salt concentrations.

### SUMMARY OF INVENTION

According to a first aspect of the invention there is provided a method of forming a swellable oilfield apparatus, the method comprising: providing the apparatus with a body of swellable elastomeric material which increases in volume on exposure to at least one triggering fluid; and modifying a surface energy of the swellable elastomeric material to increase the water-wettability of the swellable elastomeric material.

It has been appreciated by the present inventors that modifying the surface energy of the swellable elastomeric material of an oilfield apparatus to increase its water-wettability has a pronounced effect on the water-swelling performance of oilfield apparatus. The invention therefore extends to a method of improving the water-swelling performance of a swellable oilfield apparatus.

Elastomeric in this context means having the physical or mechanical properties of a rubber, and elastomeric material includes synthetic polymer materials and natural rubbers.

Preferably, the swellable elastomeric material comprises an ethylene propylene-based elastomer such as an ethylene propylene diene monomer rubber (EPDM), or another substantially non-polar, hydrophobic elastomer. This class of elastomer is used in hydrocarbon-swellable oilfield apparatus, but is also used as a matrix for a water-swellable elastomer to create apparatus which is operable to swell in water or brine, or in apparatus which is operable to swell in both aqueous and hydrocarbon fluids. EPDM is swellable in hydrocarbon fluids but has low water-swellability and high water-resistance due to its hydrophobic properties. The invention modifies the surface energy of the material, making it more hydrophilic and reducing the tendency to repel water molecules, thus improving the water penetration into the body.

In an alternative embodiment, the swellable elastomeric material comprises an elastomer selected to swell in water or aqueous fluids, such as a nitrile butadiene rubber (NBR) or a hydrogenated nitrile butadiene rubber (HNBR) or other substantially polar, hydrophilic elastomer This class of elastomer is used in swellable oilfield apparatus where resistance to (and low swelling in) hydrocarbon fluids is required.

The method may include the step of combining at least one additive with a base elastomer of the swellable elastomeric material, the at least one additive selected to modify the surface energy of the swellable elastomeric material.

The at least one additive may comprise one or more anti-static additive. Preferably, the one or more anti-static additive is substantially nonreactive with the base elastomer of the swellable elastomeric material. Thus the at least one additive may be blended with the base elastomer, but need not be reacted with the base elastomer. Most preferably, the additive is one which is operable to migrate or leach to the surface of the swellable elastomeric material. Anti-static additives displaying this property have been found to effectively modify the surface energy of the swellable elastomeric material, and improve the wettability of the material and the penetration of water into a body formed from the material.

The anti-static additives may be for example fatty acid esters, ethoxylated alkylamines, ethers, thioethers, ether thioethers and/or alkylsulfonates.

A preferred class of additive is one comprising an ether or thioether group. Additives comprising ether or thioether groups have been found to improve the swelling of a body of swellable elastomeric material when compared with the same swellable elastomeric material which omits such an additive.

In one embodiment, the at least one additive comprises an ether thioether, which may for example be the ether thioether commercially available from Lanxess Deutschland GmbH under the registered trade mark VULKANOL® 85, although chemically similar compounds may also be used.

In another embodiment, the at least one additive comprises a fatty alkyl ester, which may for example be the fatty alkyl ester of polyethylene glycol, commercially available from Rhein Chemie Rheinau GmbH, Germany under the trade mark Rhenosin® RC100, although chemically similar compounds may also be used.

The method may comprise the step of combining about 1 to 50 phr (per hundred rubber) additive with a base elastomer.

In a preferred embodiment, the method includes the step of combining 1 to 15 phr, more preferably about 8 phr, of the additive with the base elastomer.

In an alternative embodiment of the invention, the method includes the step of modifying the surface energy of the swellable elastomeric material by an electrical treatment process. The electrical treatment process may comprise exposing the swellable elastomeric material to an electrical discharge. The electrical discharge may be high voltage and/or high frequency.

Preferably, the electrical treatment process is a corona treatment or air plasma (or atmospheric plasma) treatment process.

The process may comprise the step of forming the body on the oilfield apparatus and exposing the swellable elastomeric material to an electrical treatment process in situ on the apparatus. This embodiment may be preferred in certain instances, for example where subsequent processing of the swellable elastomeric material may adversely affect the modified surface energy.

The electrical treatment process may include the step of translating an electrode relative to the swellable elastomeric material. Where the body is elongated, the electrode may be translated longitudinally relative to the body. The electrode may be scanned over the swellable elastomeric material, and may be positionally indexed relative to the swellable elastomeric material. Multiple passes or scans may therefore treat different parts of a surface of the swellable elastomeric material.

The electrode may form a part of a fixed treatment station, and the swellable elastomeric material may be translated relative to the electrode. The treatment station may comprise an array of electrodes.

Alternatively, or in addition, an electrode may form part of a manually-operated spot treatment apparatus.

Alternatively, the method may include the steps of treating the swellable elastomeric material before applying to the apparatus. In some embodiments, a treatment station is configured to treat a web or sheet of material, and may comprise one or more rollers.

The swellable elastomeric material may be treated in a sheet or calendered form, or may be in the form of an elongated strip. For example, the swellable elastomeric material may be used to form the body in the manner described in the applicant's co-pending patent application number GB0902559.4. In this method, layers of partially-cured or substantially-cured elastomeric material are used to form a body of elastomeric material on a downhole apparatus. Thus, in an embodiment of the present invention, an electrical discharge process may be carried out on the sheets of partially- or substantially-cured swellable elastomeric material before application to the downhole apparatus.

In certain embodiments, the method includes the steps of treating one or more elastomer constituents to modify the surface energy of the one or more constituents, prior to compounding the one or more constituents to form the swellable elastomeric material.

The improved water wettability of the material lends itself to applications to water-swellable elastomer systems and hybrid swellable elastomer systems. Accordingly, the method preferably comprises the step of providing at least one water-swellable material in the body, which may be for example an N-vinylcarboxylic acid amide-base cross-linked resin and a water swellable urethane. Alternatively, or in addition, the water-swellable material may comprise a Super Absorbent Polymer, such as sodium polyacrylates or acrylic acids.

In a preferred embodiment the base elastomer provides a matrix for the water-swellable material. By modifying the surface energy, the inventors have found that the hydrophobic properties of the base elastomer may be mitigated to increase penetration of water into the body, and therefore improve the access of water to the water-swellable material within the body. This has the desirable effect of increasing water-swelling properties of the body, including swell rate and swell volume. Thus in an embodiment of the invention, the body may comprise a matrix of a substantially non-polar, hydrophobic elastomer such as an ethylene propylene-based elastomer, and a water-swellable material, such as a Super Absorbent Polymer, incorporated into the matrix.

According to a second aspect of the invention there is provided a swellable oilfield apparatus comprising a body of swellable elastomeric material operable to increase in volume on exposure to at least one triggering fluid; wherein the swellable elastomeric material comprises a base polymer and at least one additive selected to modify the surface energy of the swellable elastomeric material.

Preferably, the at least one additive comprises one or more anti-static compounds.

Embodiments of the second aspect of the invention may comprise preferred and/or optional features of the first aspect of the invention or vice versa.

According to a third aspect of the invention there is provided a swellable oilfield apparatus comprising a body of swellable elastomeric material operable to increase in volume on exposure to at least one triggering fluid; wherein the swellable elastomeric material comprises a base polymer treated by an electrical treatment process to modify the surface energy of the swellable elastomeric material.

Embodiments of the third aspect of the invention may comprise preferred and/or optional features of any of the first or second aspects of the invention or vice versa.

According to a fourth aspect of the invention there is provided a method of forming a swellable oilfield apparatus, the method comprising: providing the apparatus with a body of swellable elastomeric material which increases in volume on exposure to at least one triggering fluid; and treating the swellable elastomeric material to increase the concentration of polar functional groups present at or near a surface of the body.

The method may include the step of treating the swellable elastomeric material to increase the concentration of polar functional groups present at or near a surface of the body relative to the concentration of polar functional groups contained within the bulk of the body.

The polar functional groups may for example comprise one or more of: carbonyl (—C═O—), carboxyl (HOOC—), hydroperoxide (HOO—) and hydroxyl (HO—) groups, ether groups, and/or thioether groups.

Embodiments of the fourth aspect of the invention may comprise preferred and/or optional features of any of the first, second or third aspects of the invention or vice versa.

According to a fifth aspect of the invention, there is provided a method of forming a swellable oilfield apparatus, the method comprising: providing the apparatus with a body of swellable elastomeric material operable to increase in volume on exposure to at least one triggering fluid; and combining at least one additive with a base elastomer of the swellable elastomeric material to modify the surface energy of the swellable elastomeric material.

Preferably, the at least one additive comprises one or more anti-static compounds.

Embodiments of the fifth aspect of the invention may comprise preferred and/or optional features of any of the first to fourth aspects of the invention or vice versa.

According to a sixth aspect of the invention, there is provided a method of forming a swellable oilfield apparatus, the method comprising: providing the apparatus with a body of swellable elastomeric material operable to increase in volume on exposure to at least one triggering fluid; and treating the swellable elastomeric material by an electrical treatment process to modify the surface energy of the swellable elastomeric material.

Embodiments of the sixth aspect of the invention may comprise preferred and/or optional features of any of the first to fifth aspects of the invention or vice versa.

According a seventh aspect of the invention, there is provided a method of forming a swellable oilfield apparatus, the method comprising: treating one or more constituents of a swellable elastomeric material by an electrical treatment process to modify the surface energy of the one or more constituents; compounding the one or more constituents to form a swellable elastomeric material operable to increase in volume on exposure to at least one triggering fluid; and providing the apparatus with a body of the swellable elastomeric material.

The body of the swellable elastomeric material may therefore have a surface energy which is modified compared with a surface energy of a body formed from untreated constituents.

The method may comprise the step of providing a volume of the one or more constituents, and exposing the volume to the electrical treatment process, which may for example be a corona treatment or a plasma treatment process. The one or more constituents may be in particulate form, and the method may include the step of arranging or distributing, for example by pouring, spreading or shaking, particles of the one or more constituents to provide the volume. The volume may be a layer of particles arranged on a surface, and the volume may have a depth dimension significantly less than at least one (and preferably two) lateral dimension(s) of the volume. The volume may be formed in a receptacle such as a tray.

Embodiments of the seventh aspect of the invention may comprise preferred and/or optional features of any of the first to sixth aspects of the invention or vice versa.

### BRIEF DESCRIPTION OF DRAWINGS

There will now be described, by way of example only, various embodiments of the invention with reference to the drawings, of which:

FIG. 1 is a schematic view of a swellable wellbore packer in a wellbore;

FIG. 2 is a block diagram showing a method of forming a swellable oilfield apparatus according to an embodiment of the invention;

FIG. 3 is a block diagram showing a method of forming a swellable oilfield apparatus according to an alternative embodiment of the invention;

FIG. 4 is a block diagram showing a method of forming a swellable oilfield apparatus according to a further alternative embodiment of the invention;

FIG. 5 is a block diagram showing a method of forming a swellable oilfield apparatus according to a further alternative embodiment of the invention;

FIG. 6 is a plot showing swelling performance over time of an elastomeric material in accordance with an embodiment of the invention compared with a reference elastomer;

FIG. 7 is a plot showing swelling performance over time of an elastomeric material in accordance with an alternative embodiment of the invention compared with a reference elastomer;

FIG. 8 is a graph showing swelling performance at two measurement times of elastomeric materials in accordance with alternative embodiments of the invention compared with a reference elastomer;

FIG. 9 is a plot showing the surface tension energy of brine solutions with varying NaCl salinities and temperature.

### DESCRIPTION OF EMBODIMENTS

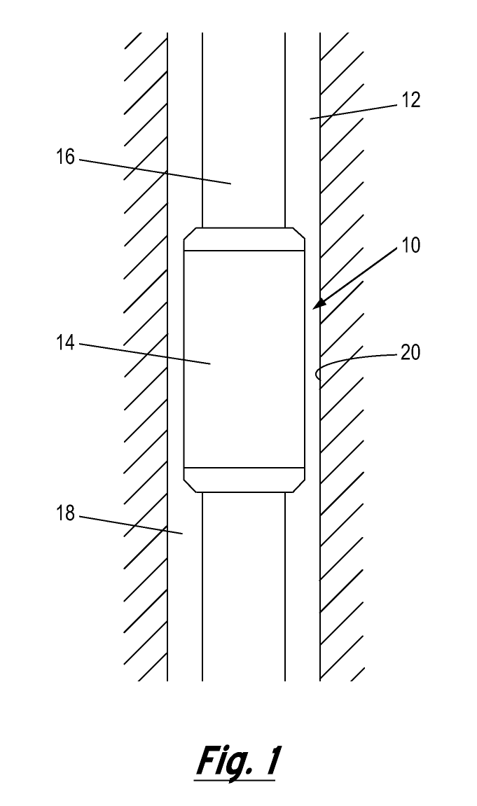

With reference firstly to FIG. 1, there is shown generally at 10 a swellable oilfield apparatus in the form of a swellable wellbore packer located downhole in a subterranean wellbore 12. The packer 10 comprises a body 14 of a swellable elastomeric material on a tubular mandrel 16. The swellable elastomeric material is, in this embodiment, operable to increase in volume in the presence of hydrocarbon or aqueous wellbore fluids (referred to herein as a “hybrid swellable” elastomer). On swelling, the body 14 contacts the surrounding wall 20 of the wellbore 12 and creates an annular barrier in the space 18.

The swellable elastomeric material which forms the body comprises a hydrocarbon swelling elastomer. Suitable elastomers include ethylene propylene-based elastomers such as an ethylene propylene diene monomer rubber (EPDM). The EPDM is a non-polar polymer with hydrophobic properties and oil swelling characteristics, and forms the base elastomer matrix of the body. The material also comprises a water-swelling material such as a super absorbent polymer, which provides the body 14 with the capability to swell in aqueous fluids and brines. The matrix makes up about 1-60% of the material volume, while the super absorbent polymers make up a further 1-30% of the volume. The remaining material is made up of fillers (such as carbon black) and other additives.

With the water-swellable and hybrid swellable elastomers of the prior art, applications have been limited by unsatisfactory swelling performance in aqueous fluids, and in particular in brines with high salt concentrations.

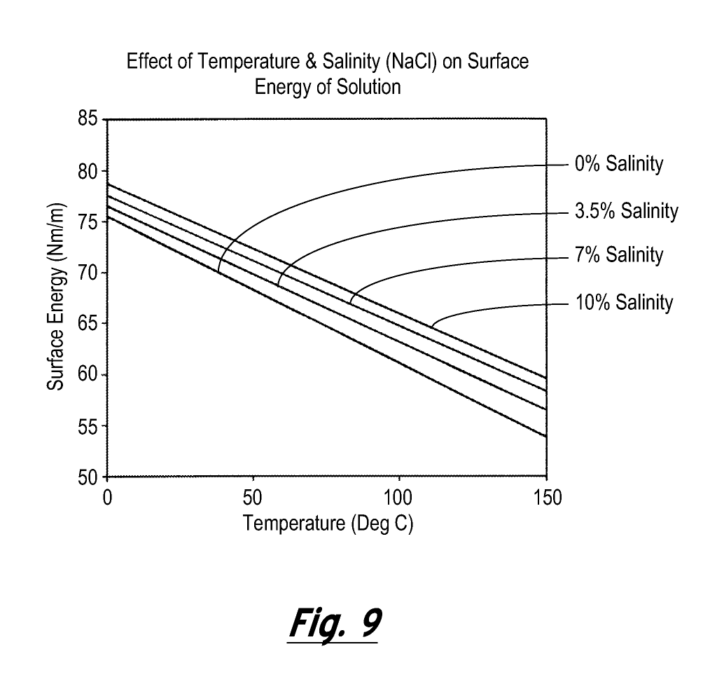

In order for a liquid to wet a surface, the surface energy of the solid must exceed the surface energy (or surface tension) of the liquid, and so by increasing the surface energy of the solid, the wettability of the surface increases. The inventors have appreciated that increased surface energy and wettability by (at least) one of the techniques described herein has a positive effect on the water-swelling performance of a swellable oilfield apparatus. The approach of the present invention is particularly advantageous where the oilfield apparatus is required to swell in brines which are commonly encountered in subsea geological formations. A plot of the effect of temperature on the surface energy of salt solutions of different concentrations is shown in FIG. 9. The data show that brines with greater salt concentration have increased surface energy. This increase in surface energy has a detrimental effect on swelling due to reduced surface wetting. The present invention provides materials with increased surface energy, and therefore increased swelling performance in brines.

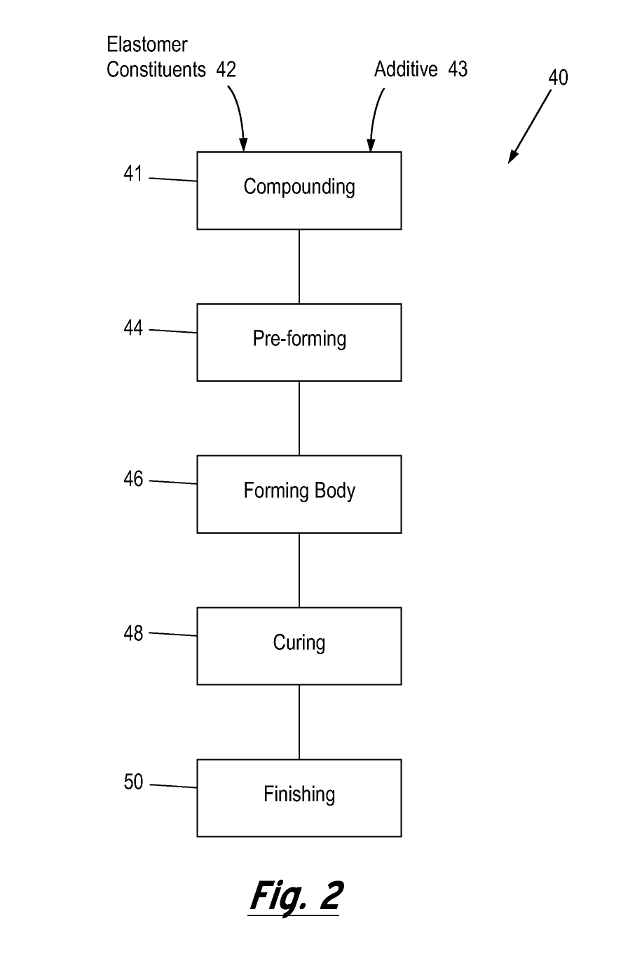

FIG. 2 is a block diagram showing steps of a method 40 of forming a swellable oilfield apparatus in accordance with an embodiment of the invention. In a first step 41 the elastomer constituents 42, which include the hydrocarbon-swellable base elastomer and a water swellable material, are compounded with an additive 43 selected to modify the surface energy of the material to be formed.

Suitable elastomer constituents include ethylene propylene-based elastomers such as an ethylene propylene diene monomer rubber (EPDM) and their precursors, and super absorbent polymers such as those commercially available from Nippon Shokubai Co., Ltd under the trade mark AQUALIC®. Suitable additives include anti-static compounds such as fatty acid esters, ethoxylated alkylamines, ethers, thioethers, ether thioethers and/or alkylsulfonates.

The mixed elastomer constituents 41 and additive 43 are subsequently pre-formed 44 into a desired shape for forming the body, for example in a calendering process to create sheets of uncured elastomer. The pre-formed uncured elastomer is then applied to the apparatus to form 46 a volume to create the body. Where the pre-formed elastomer is in the form of calendered sheets, the sheets are layered on one another to build up a volume of the swellable elastomeric material. The volume is then cured 48, for example by heat treatment in a curing oven, to create the body of swellable elastomeric material on the apparatus. The body is subsequently finished 50, for example by machining excess elastomeric material to create a cylindrical outer surface.

The resulting oilfield apparatus has a body of swellable elastomeric material comprising an additive which increases the surface energy with respect to surface energy of the material absent the additive. Additives such as the anti-static compounds described herein may be blended into the elastomeric material and are present at the surface. Thus the functional groups of the additives are present at or near the surface, and have the effect of increasing the surface energy of the elastomeric material, improving its water wettability and water-swelling performance. Selected additives, such as those having ether and/or thioether groups are blended into the material without being bound to the polymer matrix, will tend to migrate to and leach from the surface of the body. Thus there is relatively high concentration of the functional groups of the additives at the surface of the elastomeric material, which has a greater effect on the surface energy and wettability.

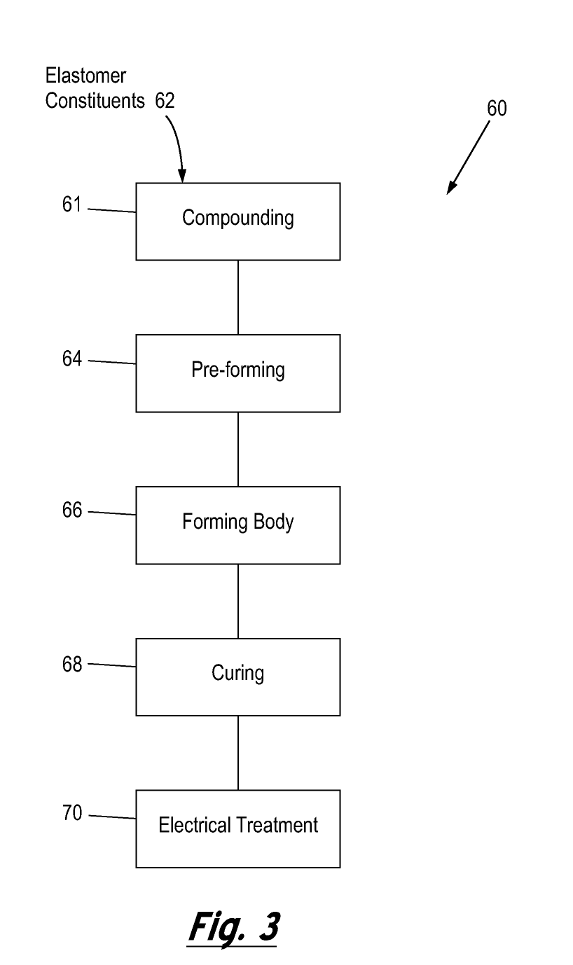

FIG. 3 is a block diagram showing steps of a method 60 of forming a swellable oilfield apparatus in accordance with an embodiment of the invention. In a first step 61, the elastomer constituents 62, which may be the same as those as described in the method 40 of FIG. 2, are compounded to create the mixture, which is subsequently pre-formed 64 into a desired shape for creating the body (for example by calendering). The pre-formed uncured elastomer is then applied to the apparatus to form 66 a volume to create the body (for example by forming layers of calendered sheets). The volume is then cured 68, for example by heat treatment in a curing oven, to create the body of swellable elastomeric material on the apparatus.

It will be noted that steps 61 to 68 are conventional in the field of swellable oilfield apparatus manufacture. However, the formed body is subsequently treated to modify the surface energy of the material in an electrical treatment process 70. Suitable treatment processes include those described as corona discharge treatment and air (or atmospheric) plasma treatment processes. Corona discharge processes are known in the plastic film, extrusion, and converting industries to improve bonding of inks, coatings and adhesives. A typical process exposes a material to a high-frequency, high-voltage electrical discharge. Power from an available power source, such as a mains utility supply, is converted into high frequency high voltage power which is then supplied to a treatment station, which applies this power through ceramic or metal electrodes over an air gap onto the surface of the material.

The corona discharge process works by generating free radicals, at the surface of the material, which in the presence of oxygen can react to form functional chemical groups at the material surface, without affecting the properties of the bulk material. These functional groups, which may include carbonyl (—C═O—), carboxyl (HOOC—), hydroperoxide (HOO—) and hydroxyl (HO—) groups have the effect of increasing the surface energy of the swellable elastomeric material. Examples of suitable corona treatment processes which may be applied to or adapted for the present invention are described in U.S. Pat. No. 3,135,676, U.S. Pat. No. 3,192,385, U.S. Pat. No. 3,376,208, U.S. Pat. No. 3,888,753, and U.S. Pat. No. 4,836,901.

In embodiments of the present invention, the body of swellable elastomeric material is treated as part of an automated corona discharge process on a production line.

In one configuration, the corona treatment system includes rotating corona electrode elements which rotate around the body of elastomeric material as it is translated relative to the electrodes. In an alternative arrangement, the electrode is configured to be translated relative to the body to scan over a portion of the body. The body is rotationally mounted, and is rotationally indexed at the end of a pass of the electrode. A return pass of the electrode scans a different part of the surface of the body, and the body is rotationally indexed between multiple passes of the electrode until the entire surface is covered. This configuration may be particularly suitable for the treatment of the surface of a swellable body of a downhole packer. The packer may be mounted on a spindle such that it may be rotationally indexed as an electrode is passed over the surface. In alternative configurations, the body maybe continuously rotated during relative longitudinal movement of the electrodes.

In another configuration, the electrical treatment is carried out by systematic application of a discharge electrode over the surface or surfaces of the elastomer body. The discharge electrode may be part of a handheld wand which is manipulated by a user to treat parts of the surface of the body. An example of suitable equipment is the high frequency spot generator commercially available from Tantec AS, marketed under the SpotTEC trade mark. This is a portable unit which runs from a conventional mains electricity supply, with a power output in the range of around 500 watts to 1200 watts, with an output voltage of 2×6.5 kV. Treatment widths are available from the 40 millimetres up to 150 millimetres. Advantages of using a spot treatment corona generator such as that described above include simple handling, portability, low capital cost, flexible treating depths and processing speeds. A unit of this type may also be incorporated into existing production lines relatively quickly and easily.

The resulting oilfield apparatus has a body of swellable elastomeric material which is treated to increase the surface energy with respect to surface energy of the material which has not undergone the treatment. The relatively high concentration of the functional groups at the surface of the elastomeric material has effect on the surface energy and wettability.

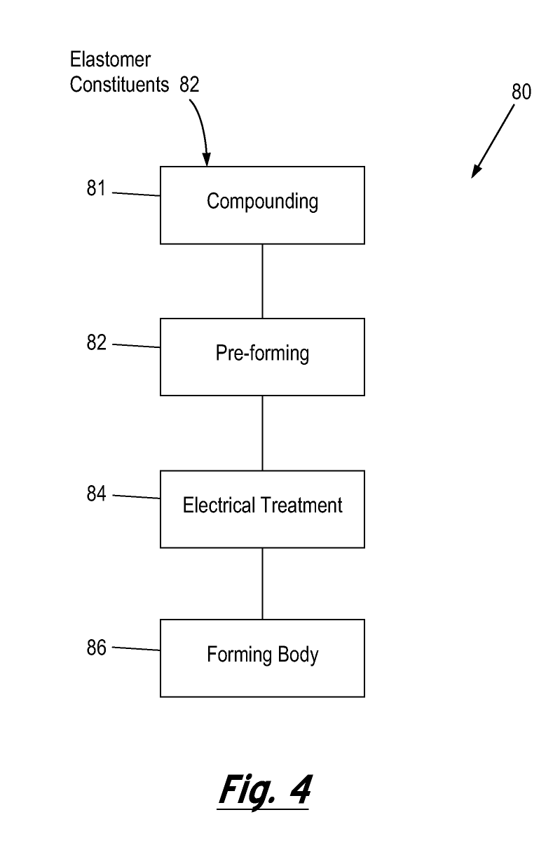

FIG. 4 is a block diagram showing steps of a method 80 of forming a swellable oilfield apparatus in accordance with an alternative embodiment of the invention. The method is similar to and will be understood from the method 60 of FIG. 3. However, the method 80 differs in that the electrical treatment process is performed on the pre-formed elastomeric material, prior to forming the body of swellable elastomeric material on the oilfield apparatus itself. Such a method may involve the manufacturing steps described in the applicant's co-pending patent application number GB0902559.4. In this method, calendered sheets of elastomeric material are partially-cured or substantially-cured as part of the pre-forming 82 process. These partially-cured or substantially-cured layers are then subject to the electrical treatment 84 to increase their surface energy, in the manner outlined above. The corona electrode is applied to the calendered sheets as part of an automated production process, which may for example be adapted from known production processes in the field of paper or film treatment.

In one embodiment, the treating station comprises a roller system and a linear electrode assembly which is arranged to receive a calendered sheet with a width from 500 to 3000 millimetres. Multi-fin electrode elements are arranged in the electrode assembly across the width of the station. The equipment may be arranged for single or double-sided treatment.

Following the treatment, the calendered sheets are used to form 86 the body of swellable material of the oilfield apparatus, in the manner outlined by GB0902559.4.

The resulting oilfield apparatus has a body of swellable elastomeric material which is treated to increase the surface energy with respect to surface energy of the material which has not undergone the treatment. Treating a partially-cured or substantially-cured elastomer aids handling and manufacturing. The functional groups are distributed throughout the body of the apparatus, increasing surface energy and wettability.

In alternative embodiments of the invention, a body is formed by one or more of the processes outlined above and then subsequently applied to a swellable oilfield apparatus. For example, a swellable mantle for a wellbore packer is formed in a mould, and then is subsequently disposed on a tubular mandrel of the packer by slipping it onto the mandrel.

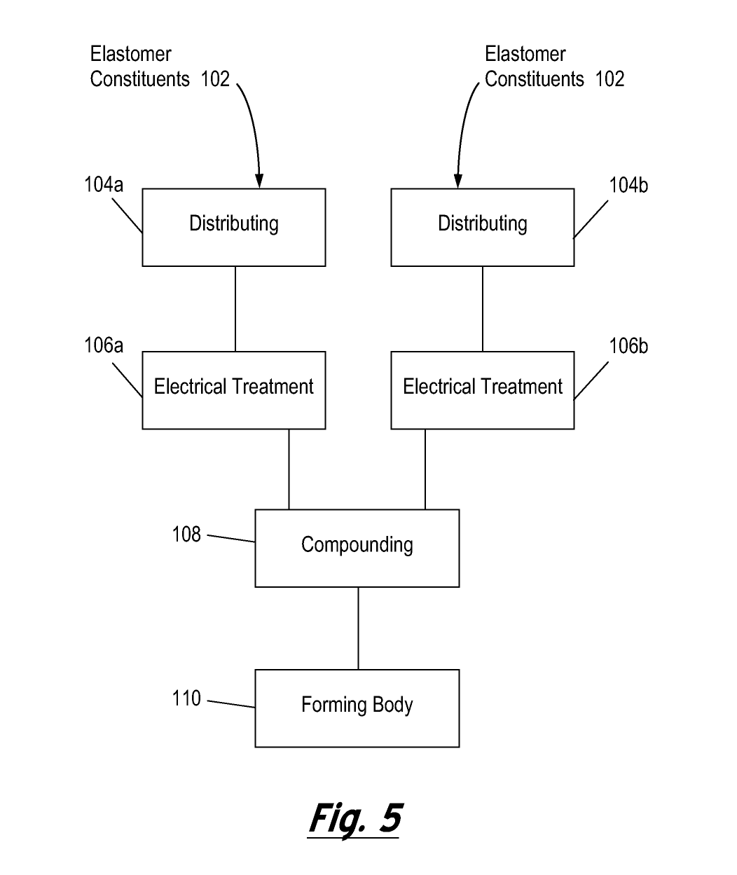

FIG. 5 is a block diagram showing steps of a method 100 of forming a swellable oilfield apparatus in accordance with a further alternative embodiment of the invention. The method is similar to and will be understood from the methods 60 and 80 of FIGS. 3 and 4. However, the method 100 differs in that the electrical treatment process is performed on constituents of the elastomeric material, prior to compounding the elastomeric material.

Constituents 102 of the elastomeric material, which include for example one or more base polymers (or their precursors) for forming the matrix of the swellable material, superabsorbent polymers (SAPS) to be blended into the base polymer matrix, and/or fillers such as carbon black are distributed 104a, 104b or arranged to allow the electrical treatment to be applied. Typically, the elastomer constituents 102 will be in solid particulate form, and the distributing steps 104a, 104b involve arranging or spreading a layer of the constituents on the surface of a receptacle such as a tray. It is advantageous for the constituents to be arranged in a layer that is sufficiently thin to allow the treatment process, applied from an upper surface, to penetrate the majority of particles in the layer. For efficient processing, the layer can be provided over a large surface area.

The upper surface of the layer of the elastomer constituents is then subject to electrical treatment process 106a, 106b, such as the corona treatment process described with reference to FIG. 3. A spot-treatment electrode wand is scanned over the surface of the layer of the elastomer constituents to increase the surface energy of the particles. The plasma treatment is applied for a sufficient time and with sufficient repeat passes to optimise the surface energy. Time between passes is chosen to avoid overheating of the elastomer constituents, which may cause them to degrade.

It will be appreciated that steps 102a and 102b, or steps 104a, 104b may be performed on the different elastomer constituents sequentially or in parallel, depending on available resources.

The treated elastomer constituents are subsequently compounded together in step 108. Further processing is carried out at step 110 to form the body for the oilfield apparatus. This may include pre-forming such as a calendering and/or moulding, in addition to curing of the elastomer material to form the body.

In an alternative configuration, the particulate elastomer constituents are distributed on a conveying system which passes beneath a fixed corona electrode assembly. Other automated or semi-automated processes may be used in alternative embodiments of the invention.

As an alternative to the corona treatment process, an air plasma or atmospheric plasma treatment process may be used in embodiments of the invention. Plasma treatment processes operate in a similar manner to corona treatment processes. However, plasma treatment is the electrical ionisation of a gas by the electrode. One advantage of a plasma treatment process is that the plasma may be created at much lower voltage levels than those used in corona processes (which may be around 6 kV to 10 kV). Like corona treatment, plasma treatment can be applied manually or as part of an automated or semi-automated production line process. The use of a plasma treatment process may be preferred over corona treatment in some applications. Benefits of plasma treatments include a longer retention of treatment levels when compared with corona treatment; potentially higher treatment levels for materials which do not respond well to the corona process; and the treatment of thicker layers or substrates of material.

### EXAMPLES

Exemplary elastomer compounds were prepared and treated in accordance with the invention, as described below. A reference base elastomer E0 was prepared by compounding calendering grade EPDM base polymer with carbon black as a filler, processing oil, a cross-linking agent, and a super-absorbent polymer. The compounded mixture was calendered and vulcanised to provide a plurality of samples. The dispersive, polar, and total surface energies of the samples were measured using a contact angle meter and reference fluids. The data is presented in Table 1A & Table 1B below.

### Example 1

The method 40 of FIG. 2 was performed by compounding calendering grade EPDM base elastomer with carbon black as a filler, processing oil, a cross-linking agent, and a super-absorbent polymer. The anti-static additive VULKANOL® 85, in the amount 8 phr, was mixed with the elastomer constituents. The compounded mixture was calendered and vulcanised. The dispersive, polar, and total surface energies of the samples were measured using a contact angle meter and reference fluids. The data is presented in Table 1A below, labelled E1. The data show a marked increase in surface energy, particularly in polar surface energy.

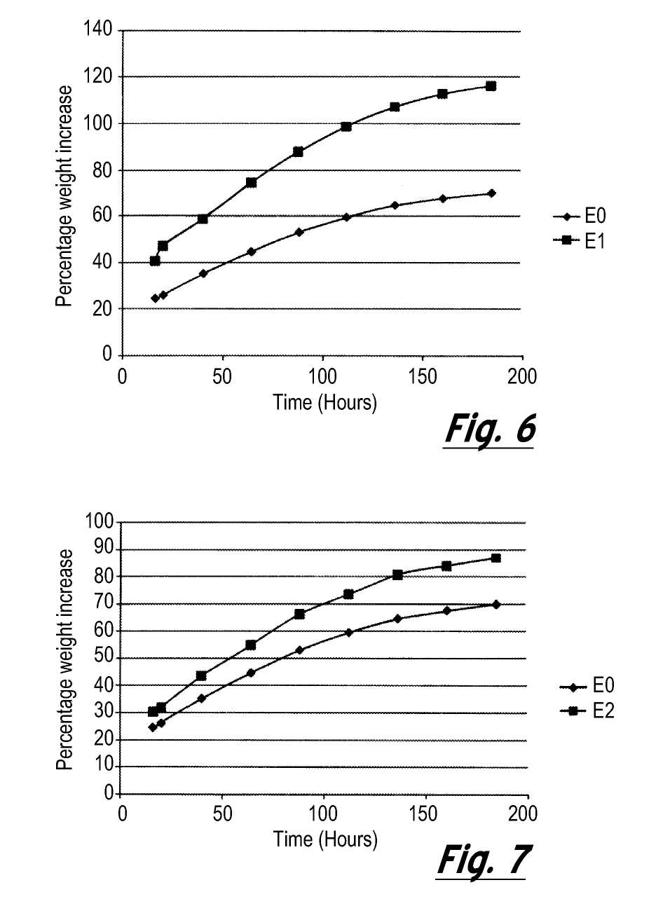

The sample was placed in 2% brine at a controlled temperature of 95° C., and percentage weight increase of the sample was measured at intervals. FIG. 6 is a plot of percentage mass change versus time for the elastomer E1 and the base reference elastomer E0. The data show a clear increase in swelling performance for the swellable material containing the anti-static additive compared to the swellable material with no anti-static additive. Across the measurement timeframe, the average increase in swelling performance was approximately 65%.

### Example 2

The method 40 of FIG. 2 was performed by compounding calendering grade EPDM base elastomer with carbon black as a filler, processing oil, a cross-linking agent, and a super-absorbent polymer. The anti-static additive RHENOSIN™ RC100, in the amount 8 phr, was mixed with the elastomer constituents. The compounded mixture was calendered and vulcanised. The dispersive, polar, and total surface energies of the samples were measured using a contact angle meter and reference fluids. The data is presented in Table 1A below, labelled E2. The data show a marked increase in surface energy, particularly in polar surface energy.

The sample was placed in 2% brine at a controlled temperature of 95° C., and percentage weight increase of the sample was measured at intervals. FIG. 7 is a plot of percentage mass change versus time for the elastomer E2 and the base reference elastomer E0. The data show a clear increase in swelling performance for the swellable material containing the anti-static additive compared to the swellable material with no anti-static additive. Across the measurement timeframe, the average increase in swelling performance was approximately 23%.

### Example 3

The method 60 of FIG. 3 was carried out by performing a corona discharge treatment process on the base elastomer E0. The sample was exposed to an electrical discharge from a manually operated spot-treatment electrode wand, operating at a power in the range of 500 to 1200 W with an output voltage of 6.5 kV. The wand was passed over the surface at a rate of approximately 15 cm to 75 cm per second, with multiple passes of the electrode over the body.

The dispersive, polar, and total surface energies of the samples were measured using a contact angle meter and reference fluids. The data is presented in Table 1B below, labelled E3. The data show a marked increase in surface energy, particularly in polar surface energy.

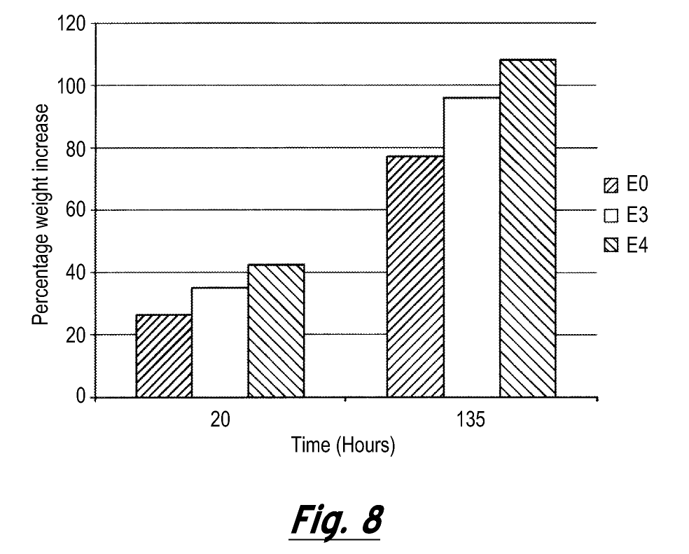

The sample was placed in 2% brine at a controlled temperature of 95° C., and percentage weight increase of the sample was measured after 20 hours and 135 hours. FIG. 8 is a plot of percentage mass change for the elastomer E3 and the base reference elastomer E0. The data show a clear increase in swelling performance for the swellable material treated by the corona treatment process. The improvement in swelling performance after 20 hours was approximately 33% and after 135 hours was approximately was 24%.

### Example 4

The method 60 of FIG. 3 was carried out by performing an atmospheric plasma treatment process on the base elastomer E0. The sample was exposed to an electrical discharge from a manually operated spot-treatment electrode wand, commercially available from Tantec AS under the trade mark PLASMATEC. The wand was passed over the surface at a rate of approximately 15 cm to 75 cm per second, with multiple passes of the electrode over the body.

The dispersive, polar, and total surface energies of the samples were measured using a contact angle meter and reference fluids. The data is presented in Table 1B below, labelled E4. Once again, the data show a marked increase in surface energy, particularly in polar surface energy.

The sample was placed in 2% brine at a controlled temperature of 95° C., and percentage weight increase of the sample was after 20 hours and 135 hours. FIG. 8 also shows percentage mass change for the elastomer E4 and the base reference elastomer E0. The data show a clear increase in swelling performance for the swellable material treated by the corona treatment process. The improvement in swelling performance after 20 hours was approximately 60% and after 135 hours was approximately was 40%.

TABLE 1A

Elastomer

Surface

| energy | | E1 (Anti-stat 1) | | E2 (Anti-stat 2) | |
|---|---|---|---|---|---|
| (Nm/m) | E0 (base) | | % change | | % change |
| Dispersive | 24.56 | 28.82 | 17.35% | 27.08 | 10.26% |
| Polar | 1.16 | 2.28 | 96.55% | 32.62 | 2712% |
| Total | 25.72 | 31.10 | 20.92% | 59.70 | 132.1% |

TABLE 1B

Elastomer

Surface

| energy | | E3 (Corona) | | E4 (Plasma) | |
|---|---|---|---|---|---|
| (Nm/m) | E0 (base) | | % change | | % change |
| Dispersive | 24.56 | 35.82 | 45.85% | 39.81 | 62.09% |
| Polar | 1.16 | 30.22 | 2505% | 30.13 | 2497% |
| Total | 25.72 | 66.04 | 156.8% | 69.94 | 171.9% |

Various modifications and improvements to the above described embodiments fall within the scope of the invention. For example, although foregoing description is described with reference to wellbore packers, the invention is not so limited. It may also be applied to other types of oilfield apparatus, including but not limited to centralisers, annular barriers, anchors, collars, and actuators.

The elastomeric materials described above are hybrid elastomers with the ability to swell in both hydrocarbon and aqueous fluids, but the present invention also applies to other categories of materials, for example those for use in low-oil swelling applications or water-swelling applications only.

The specification describes corona treatment processes and plasma treatment processes for increasing the surface energy of the material, but other similar processes are known in the plastic film, extrusion, and converting industries to improve bonding of inks, coatings and adhesives and may be used according to the invention for the production of oilfield equipment. Such processes include for example gas corona, flame plasma and chemical plasma treatments, including bare roll, covered roll and universal roll variations. Various fixed electrode, rotating electrode, spot treatment, or web treatment processes are within the scope of the invention.

The principles of the invention may also be applied to extrusions of swellable elastomeric material or elongated sections of material which are designed to be coiled or otherwise wrapped on a mandrel to form a swellable body.

The invention and its embodiments provide a number of benefits in the field of swellable oilfield apparatus. It allows for improved swelling performance in the presence of water, or in the presence of both hydrocarbon and water, such as may typically be encountered in oilfield operations. In particular, the present invention provides for improved water-swelling performance in high-concentration brines, compared with the swellable elastomeric materials of the prior art.

Further modifications and improvements may be made without departing from the scope of the invention herein described. Combinations of features not specifically claimed herein fall within the scope of the invention.

What is claimed is:

1. A method of forming a swellable oilfield apparatus, the method comprising:
providing the apparatus with a body of swellable elastomeric material which increases in volume on exposure to at least one triggering fluid; and
modifying a surface energy of the swellable elastomeric material to increase the water-wettability of the swellable elastomeric material.

2. The method as claimed in claim 1 wherein the swellable elastomeric material comprises an elastomer operable to swell in a hydrocarbon fluid.

3. The method as claimed in claim 2 comprising the step of providing at least one water-swellable material in the body.

4. The method as claimed in claim 1 comprising the step of providing at least one water-swellable material in the body.

5. The method as claimed in claim 1, including the step of combining at least one additive with a base elastomer of the swellable elastomeric material, the at least one additive selected to modify the surface energy of the swellable elastomeric material.

6. The method as claimed in claim 5 wherein the additive is selected to migrate or leach to the surface of the swellable elastomeric material.

7. The method as claimed in claim 5, wherein the additive is selected from the group consisting of: fatty acid esters, ethoxylated alkylamines, ethers, thioethers, ether thioethers, and alkylsulfonates.

8. The method as claimed in claim 1 comprising the step of modifying the surface energy of the swellable elastomeric material by an electrical treatment process.

9. The method as claimed in claim 8 wherein the electrical treatment process is a corona treatment or atmospheric plasma treatment process.

10. The method as claimed in claim 8 comprising the steps of forming the body on the oilfield apparatus and exposing the swellable elastomeric material to an electrical treatment process in situ on the apparatus.

11. The method as claimed in claim 8 comprising the steps of treating the swellable elastomeric material before applying the material to the apparatus.

12. The method as claimed in claim 8 comprising the step of treating one or more elastomer constituents to modify the surface energy of the one or more constituents, prior to compounding the one or more constituents to form the swellable elastomeric material.

13. A swellable oilfield apparatus comprising a body of swellable elastomeric material operable to increase in volume on exposure to at least one triggering fluid; wherein the swellable elastomeric material comprises a base elastomer and at least one additive selected to modify the surface energy of the swellable elastomeric material.

14. The apparatus as claimed in claim 13 wherein the swellable elastomeric material comprises an elastomer operable to swell in a hydrocarbon fluid.

15. The apparatus as claimed in claim 13 wherein the additive is selected to migrate or leach to the surface of the swellable elastomeric material.

16. The apparatus as claimed in claim 13 wherein the additive is selected from the group consisting of: fatty acid esters, ethoxylated alkylamines, ethers, thioethers, ether thioethers, and alkylsulfonates.

17. The apparatus as claimed in claim 13 wherein the body comprises at least one water-swellable material.

18. A swellable oilfield apparatus comprising a body of swellable elastomeric material operable to increase in volume on exposure to at least one triggering fluid; wherein the swellable elastomeric material comprises a base elastomer treated by an electrical treatment process to modify the surface energy of the swellable elastomeric material.

19. The apparatus as claimed in claim 18 wherein the swellable elastomeric material comprises an elastomer operable to swell in a hydrocarbon fluid.

20. The apparatus as claimed in claim 18 wherein the body comprises at least one water-swellable material.
